(19) United States
(12) Patent Application Publication
(10) Pub. No.: US 2014/0092349 A1
(43) Pub. Date: Apr. 3, 2014

(54) TN-MODE LIQUID CRYSTAL DISPLAY DEVICE

(71) Applicant: FUJIFILM Corporation, Tokyo (JP)

(72) Inventors: Ryo NAKAMURA, Kanagawa (JP); Hiroshi SATO, Kanagawa (JP)

(73) Assignee: FUJIFILM Corporation, Tokyo (JP)

(21) Appl. No.: 14/031,764

(22) Filed: Sep. 19, 2013

(30) Foreign Application Priority Data
Sep. 28, 2012 (JP) 2012-215993
Jul. 9, 2013 (JP) 2013-143361

(51) Int. Cl. G02F 1/13363

(52) U.S. Cl. CPC G02F 1/13363
USPC 349/102

(57) ABSTRACT

A TN-mode liquid crystal display device, which exhibits reduced grayscale inversion and improved white luminance, including: in sequence, a first polarizer, a first retardation film, a first liquid crystal cell substrate, a TN-mode liquid crystal layer, a second liquid crystal cell substrate, a second retardation film, and a second polarizer, wherein the absorption axis of the first polarizer is orthogonal to the absorption axis of the second polarizer, the slow axis of the first retardation film tilts by about 45° from the absorption axis of the first polarizer, the slow axis of the second retardation film tilts by about 135° from the absorption axis of the second polarizer, the slow axis of the first retardation film is orthogonal to the slow axis of the second retardation film, the first retardation film and the second retardation film have the same Re(550), and the first retardation film has a Re(550) of 5≦Re(550)≦55.

### FIELD OF THE INVENTION

The present invention relates to a liquid crystal display device of a TN mode.

### BACKGROUND ART

A disadvantage of a TN-mode liquid crystal display device lies in its susceptibility to grayscale inversion. A conventional TN-mode liquid crystal display device includes an optical compensation film to compensate for residual retardation during a black display mode, and thereby reduces grayscale inversion to a certain level.

Japanese Unexamined Patent Application Publication No. 2006-285220 discloses the use of a liquid crystal display device of a birefringence mode for a reduction in grayscale inversion.

### SUMMARY OF THE INVENTION

The present inventors have found that a birefringence-mode liquid crystal display device, which generally causes reduced grayscale inversion, is likely to provide reduced frontal luminance during a white display mode (hereinafter simply referred to as “white luminance”) as a result of intensive study. An object of the present invention, which has been made to overcome such problems, is to provide a liquid crystal display device that exhibits reduced downward grayscale inversion with improved white luminance.

The present inventors, who have diligently studied under such a circumstance, have also found that the above-mentioned problems can be solved by the use of a retardation film having a predetermined slow axis angle and a retardation in-plane Re at a wavelength of 550 nm within the range of 5≦Re(550)≦55. In specific, the above-mentioned problems can be solved by a liquid crystal display device described as below.

<1> A liquid crystal display device comprising: in sequence, a first polarizer, a first retardation film, a first liquid crystal cell substrate, a second liquid crystal cell substrate, a second retardation film, and a second polarizer, and a liquid crystal layer between the first liquid crystal cell substrate and the second liquid crystal cell substrate, wherein, in the liquid crystal layer, liquid crystal molecules are encapsulated so that the liquid crystal molecules form twisted-alignment by about 90° from one of the liquid crystal cell substrates to the other of the liquid crystal cell substrates,

the absorption axis of the first polarizer is orthogonal to the absorption axis of the second polarizer,

the slow axis of the first retardation film tilts by about 45° from the absorption axis of the first polarizer,

the slow axis of the second retardation film tilts by about 135° from the absorption axis of the second polarizer,

the slow axis of the first retardation film is orthogonal to the slow axis of the second retardation film,

the first retardation film and the second retardation film have the same retardation in plane Re(550) at a wavelength of 550 nm, and

the first retardation film has a retardation in plane Re(550) within a range of 5≦Re(550)≦55.

<2> The liquid crystal display device according to <1>, wherein the first retardation film and the second retardation film each are obliquely-stretched biaxial films, and each of the obliquely-stretched biaxial films has an angle θ within a range of 0<θ<90 defined by the longitudinal direction of the obliquely-stretched biaxial film and the slow axis of the first retardation film.
<3> The liquid crystal display device according to <1> or <2>, wherein the first retardation film has a slow axis angle 8 within a range of 40<θ<50.

### Advantageous Effects of Invention

According to the present invention, a TN-mode liquid crystal display can be provided which exhibits reduced grayscale inversion and improved white luminance.

### BRIEF DESCRIPTION OF THE DRAWINGS

FIG. 1 is a conceptual diagram illustrating the direction of the axis according to the present invention.

FIG. 2 is a schematic diagram illustrating an exemplary liquid crystal display device according to the present invention.

### DETAILED DESCRIPTION OF THE INVENTION

The present invention will now be described in detail. In this description, the numerical range expressed by the wording “a number to another number” means the range that falls between the former number indicating the lowermost limit of the range and the latter number indicating the uppermost limit thereof. First described are the terms used in this description.

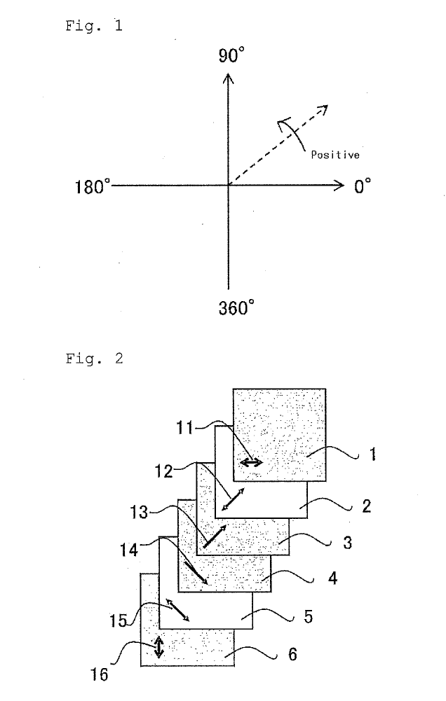

For convenience of explanation, the angles described herein are ones relative to the lower hem of the screen of a liquid crystal display device at 0° as seen from the normal direction of the screen, and an angle in a counterclockwise direction is represented as positive. For example, if FIG. 1 illustrates the screen, the arrow indicates the direction toward positive. The dashed arrow thus indicates +45°. Such a positioning of the lower hem of the screen of a liquid crystal display at 0°, however, is not essential to the liquid crystal display device including a retardation film and a polarization plate according to the present invention.

The term “about” in “about 90°”, for example, means that an error from the exact angle ranges from more than −5° to less than +5°. The error preferably ranges from more than −4° to less than +4°, and more preferably from more than −3° to less than +3°.

In addition, the terms “parallel” and “orthogonal” used herein include an error ranging from −5° to +5° from the exact angle. The error preferably ranges from more than −4° to less than +4°, and more preferably from more than −3° to less than +3°.

A liquid crystal display device according to the present invention is characterized in that the liquid crystal display device comprises: in sequence, a first polarizer, a first retardation film, a first liquid crystal cell substrate, a second liquid crystal cell substrate, a second retardation film, and a second polarizer, and a liquid crystal layer between the first liquid crystal cell substrate and the second liquid crystal cell substrate, wherein, in the liquid crystal layer, liquid crystal molecules are encapsulated so that the liquid crystal molecules form twisted-alignment by about 90° from one of the liquid crystal cell substrates to the other of the liquid crystal cell substrates, the absorption axis of the first polarizer is orthogonal to the absorption axis of the second polarizer, the slow axis of the first retardation film tilts by about 45° from the absorption axis of the first polarizer, the slow axis of the second retardation film tilts by about 135° from the absorption axis of the second polarizer, the slow axis of the first retardation film is orthogonal to the slow axis of the second retardation film, the first retardation film and the second retardation film have the same retardation in plane Re(550) at a wavelength of 550 nm, and the first retardation film has a retardation in plane Re(550) within a range of 5≦Re(550)≦55.

Such a liquid crystal display device barely causes grayscale inversion and can provide improved white luminance. In general, the polarizers having a retardation of substantially λ/2 during a white display mode can achieve the best white luminance. However, the mode of the liquid crystal display device according to the present invention is complicate because the liquid crystal display device includes the liquid crystal layer, in which liquid crystal molecules are encapsulated so that the liquid crystal molecules form twisted-alignment by about 90° from one of the liquid crystal cell substrates to the other of the liquid crystal cell substrates, and therefore, the liquid crystal display device has optical rotation; and, furthermore, because the liquid crystal display device includes the polarizers and the retardation films disposed such that the absorption axes of the polarizers are not orthogonal or parallel to the slow axes of the retardation films, and therefore, the liquid crystal display device exhibits birefringence. Thus, in the liquid crystal display according to the present invention, it is difficult to adjust a retardation of substantially λ/2 by means of the liquid crystal cell. In view of such a circumstance, the present invention can successfully achieve a retardation of substantially λ/2 between the polarizers by setting an angle θ of the slow axis and the Re(550) of a retardation film to have predetermined values, respectively.

Note that “the first and second retardation films have the same retardation in plane Re(550)” means that the difference between the exact Re(550) of the first retardation film and the Re(550) of the second retardation film ranges from −5 nm to +5 nm. The difference preferably ranges from more than −3 nm to less than +3 nm, more preferably, more than −1 nm to less than +1 nm.

The structure of the liquid crystal display device according to the present invention will now be described with reference to FIG. 2. It should be understood that any other structure may be employed in the present invention.

FIG. 2 is a schematic view of an exemplary liquid crystal display device according to the present invention. The liquid crystal display device includes a first polarizer 1, a first retardation film 2, a first liquid crystal cell substrate 3, a second liquid crystal cell substrate 4, a second retardation film 5, and a second polarizer 6. The arrow 11 indicates the absorption axis of the first polarizer. The arrow 12 indicates the slow axis of the first retardation film. The arrows 13 and 14 indicate the rubbing directions of the first and second liquid crystal cell substrates, respectively. The arrow 15 indicates the slow axis of the second retardation film. The arrow 16 indicates the absorption axis of the second polarizer. In FIG. 2, the first polarizer is preferably on the viewing side of the liquid crystal display device. The following description is based on the absorption axis 11 of the first polarizer at 0°.

In the liquid crystal display device according to the present invention, the absorption axis 11 of the first polarizer is orthogonal to the absorption axis 16 of the second polarizer. In other words, the absorption axis of the second polarizer tilts 90° in FIG. 2. The slow axis of the first retardation film tilts by about 45° from the absorption axis of the first polarizer, the slow axis of the second retardation film tilts by about 135° from the absorption axis of the second polarizer. The liquid crystal display device having such a structure effectively inhibits grayscale inversion.

In the liquid crystal display device according to the present invention, the slow axis 12 of the first retardation film is preferably orthogonal to the slow axis 15 of the second retardation film, and the angle θ of the slow axis of the first retardation film is preferably within the range of 0<θ<90. For the first and second retardation films each composed of an obliquely-stretched biaxial film, the angle θ is defined by the longitudinal direction of the obliquely-stretched biaxial film and the slow axis of the first retardation film. For example, FIG. 2 illustrates the slow axis 12 of the first retardation film at +45° and the slow axis 15 of the second retardation film at −45°. Alternatively, in this embodiment, the slow axis 12 of the first retardation film may be orthogonal to the slow axis 15 of the second retardation film. The angle θ of the first retardation film may be within the range of 0<θ<90, and the angle θ of the slow axis 15 of the second retardation film may range from −90° to +90°. In more specific, the slow axis 12 of the first retardation film may be at +30°, and the slow axis 15 of the second retardation film may be at −60°. The angle 8 of the slow axis of the first retardation film is preferably within the range of 10<θ<80, more preferably 15<θ<75, further preferably 30<θ<60, further more preferably 40<θ<50, and most preferably about 45°. Such a configuration may lead to improved white luminance.

Furthermore, the liquid crystal display device according to the present invention is characterized in that the first and second retardation films have the same retardation in plane Re(550) at a wavelength of 550 nm, and that the Re(550) of the first retardation film is within the range of 5≦Re(550)≦55. Preferably, the Re(550) of the first retardation film is in the range of 10≦Re(550)≦45, and more preferably 15<Re(550)<35.

Although the retardation along the thickness direction Rth(550) of the first and second retardation films are not determined in specific, they are preferably in the range of 0≦Rth(550)≦160. In view of a wide viewing angle, the Rth(550) of these retardation films are preferably in the range of 40≦Rth(550)≦120.

The first and second retardation films may be of different types from each other, provided that they satisfy the above-mentioned requirements; however, in a preferred embodiment, they are of the same type.

In general, the first and second retardation films according to the present invention also serve as protective films for the first polarizers and the second polarizers, respectively. The first and second retardation films are obliquely-stretched biaxial films in a preferred embodiment.

Preferred examples of the retardation film include an obliquely-stretched film described in Japanese Unexamined Patent Application Publication No. 2003-342384 and a stretched film described in Japanese Unexamined Patent Application Publication No. 2011-095694 (in paragraphs [0065] to [0113]), which are incorporated herein. Preferred examples of material for a retardation film include a cyclic olefin film (preferably a norbornene film), a cellulose acylate film, and an acrylate resin film, and more preferably, a cyclic olefin film and a cellulose acylate film. Specific descriptions of these films are referred to the descriptions in Japanese Unexamined Patent Application Publication Nos. 2003-342384, 2011-095694, and 2012-25167, which are incorporated herein. In addition, the use of an obliquely-stretched biaxial film used herein essentially involves stretching of a film in an oblique direction. Such an optical manipulation can be performed in accordance with the description in Japanese Unexamined Patent Application Publication No. 2012-025167, for example.

Any polarizer can be used for the first and second polarizers of the present invention. The polarizer of the present invention may be an iodine-containing polarizer, a dye-containing polarizer using dichroic dye, or a polyene-containing polarization film. In general, an iodine-containing polarizer and a dye-containing polarizer are each made of a polyvinyl alcohol film. The absorption axis of a polarizer corresponds to the stretching direction of the film. Thus, a polarizer stretched in a longitudinal direction (transport direction) has an absorption axis parallel to the longitudinal direction, while a polarizer stretched in a lateral direction (vertical direction to the transport direction) has an absorption axis vertical to the longitudinal direction.

The sides which are not provided with the first and second polarizers, respectively, are preferably covered with protective films. Any film can be used for the protective film, such as a cellulose acylate film, cyclic olefin polymer film, polyvinyl alcohol film, polypropylene film, polycarbonate film, norbornene film, acrylic film, and PET film.

The liquid crystal cell according to the present invention includes a liquid crystal layer provided between the first liquid crystal cell substrate and the second liquid crystal substrate. The liquid crystal layer has liquid crystal molecules that are twisted by about 90° between the first and second liquid crystal cell substrates. Such liquid crystal molecules twisted by 90° are preferred for a high frontal contrast.

In the liquid crystal display device according to a preferred embodiment of the present invention, the angle defined by the rubbing direction of the first liquid crystal cell substrate and the absorption axis of the first polarizer is about 45°, while the angle defined by the rubbing direction of the second liquid crystal cell substrate and the absorption axis of the second polarizer is about 135°.

Details of the TN mode are described in Japanese Unexamined Patent Application Publication No. H06-214116, U.S. Pat. Nos. 5,583,679 and 5,646,703, and DE Patent Publication No. 3911620A1. Details of an optical compensation sheet for a liquid crystal cell of IPS mode or FLC mode are described in Japanese Unexamined Patent Application Publication No. H10-54982. These descriptions are incorporated herein.

Note that Re(λ) and Rth(λ) used herein represent retardation in plane at wavelength λ and retardation along the thickness direction at wavelength λ, respectively.

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program. When a film to be analyzed is expressed by a monoaxial or biaxial index ellipsoid, Rth(λ) of the film is calculated as follows. This measuring method may be used for measuring the mean tilt angles at the alignment layer interface and at the opposite interface of discotic liquid crystal molecules in an optically anisotropic layer.

Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film. In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR. Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (1) and (2):

$$Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) )}$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (2):

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR. In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below: cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness.

Unless otherwise specifically defined in point of the wavelength in measurement in this description, the wavelength in measurement is 550 nm.

### EXAMPLE

The invention is described in more detail with reference to the following Examples. In the following Examples, the material used, its amount and ratio, the details of the treatment and the treatment process may be suitably modified or changed not overstepping the sprit and the scope of the invention. Accordingly, the invention should not be limitatively interpreted by the Examples mentioned below.

### Example A

### (Fabrication of Retardation Film)

Pelletized thermoplastic norbornene resin (Zeon Corporation, ZEONOR1420, glass transition temperature 137° C.), which is one of cycloolefin polymer, was dried at 100° C. for five hours. The pellets were then supplied into an extruder, and were melted therein; and the melt was discharged through a polymer tube and a polymer filter, was extruded from a T-die on a casting drum into a sheet, which was then cooled, to provide a transparent resin film 1 having a thickness of 160 μm.

The transparent resin film 1 was stretched in the longitudinal direction and in the vertical direction using a tenter orienting machine for oblique stretching, which is described in FIG. 1 of Japanese Unexamined Patent Application Publication No. 2012-025167, under the control of a stretching temperature and drawing ratio, to provide a film having a slow axis in the direction shown in the table below and exhibiting the Re(550) shown in the table below.

### (Fabrication of Polarizing Plate)

A polyvinyl alcohol film having a thickness of 80 μm was stretched to five times its size in an aqueous iodine solution and was dried to provide linear polarizers each having a thickness of 20 μm.

One surface of the resulting retardation film and that of the resulting cellulose acetate film (FUJITAC, TF80UL, Fujifilm Corporation) were alkali-saponified. The two saponified surfaces of these films were respectively bonded to the both surfaces of one polarizer with an adhesive agent. The adhesive agent was 3% polyvinyl alcohol (KURARAY CO., LTD., PVA-117H) in water.

### (Fabrication of TN-Mode Liquid Crystal Display Device)

A pair of polarizing plates of a liquid crystal display device including a TN liquid crystal cell (S23A350H, Samsung Electronics Co., Ltd.) was removed. In place of the polarizing plates, two of the polarizing plates fabricated as in above were bonded to the viewing side and the backlight side, respectively, with an adhesive agent so as to provide the structure illustrated in FIG. 2.

### (Fabrication of Comparative TN-Mode Liquid Crystal Display Device)

A comparative liquid crystal display device (Comparative Example 2) was prepared which had the same structure as a liquid crystal display device according to the present invention, except commercially available cellulose acetate films (FUJITAC, TF80UL, Fujifilm Corporation) in place of the first and second retardation films.

### (Evaluation of Frontal White Luminance)

For each of the liquid crystal display devices fabricated as in above, the luminance in the frontal direction (the normal direction relative to the display surface) during a white display mode was observed using a measuring machine “EZ-Contrast XL88” (available from ELDIM). The observed white luminance was indicated with a value relative to “1” of Comparative Example 2.

TABLE 1

| | | Slow axis angle θ (°) | | | | | | | |
|---|---|---|---|---|---|---|---|---|---|
| | | −45 | 0 | 15 | 30 | 45 | 60 | 75 | 90 |
| Re(550) | 60 | | 1.00 | | 0.85 | 0.83 | 0.95 | | 1.00 |
| (nm) | 50 | | 1.00 | 1.11 | 1.03 | | 1.03 | 1.11 | 1.00 |
| | 40 | | 1.00 | 1.11 | 1.08 | 1.05 | 1.08 | 1.11 | 1.00 |
| | 30 | | 1.00 | 1.10 | 1.11 | 1.10 | 1.11 | 1.10 | 1.00 |
| | 20 | 0.75 | 1.00 | 1.07 | 1.10 | 1.11 | 1.10 | 1.07 | 1.00 |
| | 10 | | 1.00 | 1.04 | 1.07 | 1.07 | 1.07 | 1.04 | 1.00 |
| | 5 | | 1.00 | 1.02 | 1.04 | 1.04 | 1.04 | 1.02 | 1.00 |
| | 0 | | 1.00 | 1.00 | 1.00 | 1.00 | 1.00 | 1.00 | 1.00 |

The table shows the white luminance of liquid crystal display devices each including a retardation film which has the slow axis angle and exhibiting Re(550) shown in the table. The white luminance was evaluated relative to “1” of Comparative Example 2.

The table demonstrates that the liquid crystal display device including a first retardation film having an absorption axis at an angle within the range of 0<θ<90 and exhibiting Re (550) in the range of 5≦Re(550)≦55 provides an improved white luminance more than 1, whereas the liquid crystal display device including a first retardation film having an absorption axis and exhibiting Re(550) which are outside of the range provides a white luminance less than 1.

### Example B

A liquid crystal display device was prepared which includes retardation films shown in the table below in place of the retardation films of Example A, the retardation films being bonded to provide the structure illustrated in FIG. 2. The resulting liquid crystal display device was evaluated for white luminance, downward grayscale inversion, and actual image. Comparative Example 2 was evaluated in the same manner. Comparative Example 1 of a liquid crystal display device was prepared as in Comparative Example 2 except that the first polarizer had an absorption axis at 45° and the second polarizer had an absorption axis at 135°. These Comparative Examples were also evaluated for white luminance, downward grayscale inversion, and actual image. The results of the evaluation are shown in the table below.

### (Grayscale Inversion)

The grayscale inversion of each liquid crystal display device, which was fabricated as in above, was evaluated in a dark room by visual observation from a downward direction (at a polar angle of 30°) while the liquid crystal display device was displaying N1 (an image of human body) of ISO/TC130/WG2.

A: Downward grayscale inversion free of problems in practical use

B: Downward grayscale inversion having problems in practical use

### (Evaluation of Actual Image)

The viewing angle of an image displayed in each liquid crystal display device, which was fabricated as in above, was evaluated in a dark room by visual observation from an oblique direction relative to the frontal surface of the screen (optionally at a polar angle of 45°) while the liquid crystal display device was displaying N1 (an image of human body) of ISO/TC130/WG2.

A: Actual image having substantially no difference in grayscale and color between the view from the right and the view from the left and being free of problems in practical use

B: Actual image having a slight difference in grayscale and color between the view from the right and the view from the left and being free of problems in practical use (other than that falling into A)

C: Actual image having significant difference in grayscale and color between the view from the right and the view from the left and having problems in practical use

The results of the evaluation are shown in the table below.

TABLE 2

| | | Retardation film | | | Downward | | |
|---|---|---|---|---|---|---|---|
| | Relationship of | Direction of | | | grayscale | White | Evaluation of |
| | absorption axis | slow axis | Re(550) | Rth(550) | inversion | luminance | Actual image |
| Example 1 | 0/90 | 45° | 25 | 40 | A | 1.1 | B |
| | degree | | | | | | |
| | disposition | | | | | | |
| Example 2 | 0/90 | 45° | 25 | 80 | A | 1.05 | A |
| | degree | | | | | | |
| | disposition | | | | | | |
| Example 3 | 0/90 | 45° | 10 | 80 | A | 1.05 | A |
| | degree | | | | | | |
| | disposition | | | | | | |
| Example 4 | 0/90 | 45° | 40 | 80 | A | 1.05 | A |
| | degree | | | | | | |
| | disposition | | | | | | |
| Example 5 | 0/90 | 30° | 25 | 80 | A | 1.1 | A |
| | degree | | | | | | |
| | disposition | | | | | | |
| Example 6 | 0/90 | 75° | 45 | 80 | A | 1.1 | A |
| | degree | | | | | | |
| | disposition | | | | | | |
| Comparative | 45/135 | | 3 | 40 | B | 1.1 | B |
| Example 1 | degree | | | | | | |
| | disposition | | | | | | |
| Comparative | 0/90 | | 3 | 40 | A | Criterion | B |
| Example 2 | degree | | | | | | |
| | disposition | | | | | | |

The results of the evaluation demonstrate that the liquid crystal display device of the present invention can exhibit reduced downward grayscale inversion and high white luminance.

The exemplary liquid crystal display device includes the first polarizer having an absorption axis at 0° and the second polarizer having an absorption axis at 90°; however, the liquid crystal display device including the first polarizer having an absorption axis at 90° and the second polarizer having an absorption axis at 0° provided the same advantageous effects.

The present disclosure relates to the subject matter contained in Japanese Patent Application No. 215993/2012, filed on Sep. 28, 2012, and Japanese Patent Application No. 143361/2013, filed on Jul. 9, 2013, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A liquid crystal display device comprising: in sequence, a first polarizer, a first retardation film, a first liquid crystal cell substrate, a second liquid crystal cell substrate, a second retardation film, and a second polarizer; and a liquid crystal layer between the first liquid crystal cell substrate and the second liquid crystal cell substrate, wherein, in the liquid crystal layer, liquid crystal molecules are encapsulated so that the liquid crystal molecules form twisted-alignment by about 90° from one of the liquid crystal cell substrates to the other of the liquid crystal cell substrates,
the absorption axis of the first polarizer is orthogonal to the absorption axis of the second polarizer,
the slow axis of the first retardation film tilts by about 45° from the absorption axis of the first polarizer,
the slow axis of the second retardation film tilts by about 135° from the absorption axis of the second polarizer,
the slow axis of the first retardation film is orthogonal to the slow axis of the second retardation film,
the first retardation film and the second retardation film have the same retardation in plane Re(550) at a wavelength of 550 nm, and
the first retardation film has a retardation in plane Re(550) within a range of 5≦Re(550)≦55.

2. The liquid crystal display device according to claim 1, wherein the first retardation film and the second retardation film each are obliquely-stretched biaxial films, and each of the obliquely-stretched biaxial films has an angle 0 within a range of 0<θ<90 defined by the longitudinal direction of the obliquely-stretched biaxial film and the slow axis of the first retardation film.

3. The liquid crystal display device according to claim 1, wherein the first retardation film has a slow axis angle θ within a range of 40<θ<50.

4. The liquid crystal display device according to claim 1, wherein the first retardation film and the second retardation film each are obliquely-stretched biaxial films, and each of the obliquely-stretched biaxial films has an angle θ within a range of 0<θ<90 defined by the longitudinal direction of the obliquely-stretched biaxial film and the slow axis of the first retardation film, and the first retardation film has a slow axis angle θ within a range of 40<θ<50.
